(19) United States
(12) Patent Application Publication
(10) Pub. No.: US 2009/0035654 A1
(43) Pub. Date: Feb. 5, 2009

(54) LAMINATE-CASED BATTERY FORMED WITH TAB RESIN ADHERED TO PORTIONS OF TABS EXTENDED FROM LAMINATE CASING

(75) Inventor: Yasunobu KODAMA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/181,804

(22) Filed: Jul. 29, 2008

(30) Foreign Application Priority Data
Jul. 30, 2007 (JP) 2007-197512

(51) Int. Cl. H01M 2/02

(52) U.S. Cl. 429/179

(57) ABSTRACT

In a laminate-cased battery, tab resins are adhered to positive and negative tabs, except outer ends of the tabs, and inserted (i) between a casing and the positive tab and (ii) between the casing and the negative tab in areas where the positive and negative tabs cross a heat-sealed edge of the casing.

Each of the tab resins has (i) a crossing area in which the tab resin crosses the heat-sealed edge and (ii) an extension area in which the tab resin extends outward from the casing, in a direction in which the positive and negative tabs extend. Each crossing area includes a high melting point resin layer whose melting point is relatively higher than a melting point of each element that constitutes the extension areas.

### BACKGROUND OF THE INVENTION

(1) Field of the Invention

The present invention relates to a laminate-cased battery, and in particular to the construction of tab resins adhered to tabs.

(2) Description of the Related Art

Laminate-cased batteries have been prevalent with the widespread use of mobile apparatuses, such as mobile phones. The following describes the construction of a laminate-cased battery, with reference to FIGS. 1A and 1B.

As shown in FIG. 1A, a laminate-cased battery has the construction in which an electrode assembly 110 is housed in a laminate casing 75 that is formed with a metal laminate sheet. The electrode assembly 110 is composed of a positive plate 111, a negative plate 112, and a separator 113. The laminate casing 75 is formed by pressing and bending one metal laminate sheet into a bag-shape, and heat-sealing three outer edges 75b, 75c, and 75d that are open. The bent portion of the metal laminate sheet is a bottom portion 75a of the laminate casing 75.

The positive plate 111 and negative plate 112 of the electrode assembly 110 are connected to a positive tab 86 and a negative tab 87, respectively. The positive and negative tabs 86 and 87 cross the outer edge 75c positioned at an upper end of the laminate casing 75 in the z axial direction, and extend outward. Also, tab resins 96 and 97 are adhered to the positive and negative tabs 86 and 87, to increase the adhesive strength with an inner resin layer of the laminate casing 75. Also, provided in the outer edge 75c are blister portions 75c1 and 75c2 that have blisters so as to release the positive and negative tabs 86 and 87 in their thickness directions.

As shown in the enlarged part of FIG. 1A, the laminate casing 75 has a three-layer structure including a polypropylene layer 751 (hereinafter referred to as “PP layer”), an aluminum layer 752 (hereinafter referred to as “Al layer”), and a nylon layer 753 (hereinafter referred to as “Ny layer”) that are laminated in the stated order from the inside. The tab resin 96 also has a three-layer structure including a modified PP layer 961, a polyethylene naphthalate layer 962 (hereinafter referred to as “PEN layer”), and a modified PP layer 963, in the stated order from the side of the positive tab 86. Note that the reason for adopting the construction in which the tab resin 96 includes the PEN layer 962 is to prevent contact between (i) the positive and negative tabs 86 and 87 and (ii) the Al layer 752 of the laminate casing 75, by the PEN layer 962 functioning as a heat-resistant layer during the heat-sealing (see, for example, Japanese laid-open patent application No. 2000-268789, and Japanese laid-open patent application No. 2001-035477).

Generally, as shown in FIG. 1B, a circuit board 115 is attached to the laminate-cased battery, and the positive and negative tabs 86 and 87 are bent into a U shape. This improves space efficiency and substantial energy efficiency. Here, the tab resins 96 and 97 are also adhered to the portions where the positive and negative tabs 86 and 87 are bent into a U shape. Therefore, an exposed edge of the Al layer 962 of the laminate casing 75 is not in contact with the positive and negative tabs 86 and 87.

Note that the outer edges 75b and 75d, which are on both sides of the laminate casing 75 in the x axial direction of FIG. 1, are bent approximately 90[°] to improve space efficiency.

However, it is difficult for the conventional laminate-cased battery to further improve the energy efficiency by reducing a size of each of the bent portions of the positive and negative tabs 86 and 87. This is because the tab resins 96 and 97, which are adhered to the bent portions of tabs 86 and 87, are obstructions in terms of reducing the curvature radius of the bent portions of the tabs 86 and 87. Specifically, as shown in the enlarged part of FIG. 1A, the tab resins 96 and 97 each include the PEN layer 962 that has a higher heat resistance than the modified PP layers 961 and 963. The PEN layer 962 has a high bending rigidity, which makes it difficult to further reduce the curvature radius of each of the bent portions of the tabs 86 and 87.

### SUMMARY OF THE INVENTION

In view of the above-described problem, the object of the present invention is to provide a laminate-cased battery having a high quality and high energy efficiency, the tabs of which have been bent with a small curvature radius, while securely maintaining insulation between the metal layer of a laminate casing and the tabs when heat-sealing the outer edges of the laminate-cased battery.

The above object is fulfilled by a laminate-cased battery comprising: an electrode assembly including a positive plate and a negative plate; a casing that is made of a metal laminate sheet composed of a metal layer and resin layers laminated on both main surfaces of the metal layer, the metal laminate sheet being formed into a bag, so as to enclose a space substantially in a shape of a rectangular parallelepiped, an opening edge of the bag being heat-sealed with the electrode assembly housed in the bag; a positive tab that is made of a conductive material, is connected to the positive plate, and extends outward by crossing the heat-sealed edge; a negative tab that is made of a conductive material, is connected to the negative plate, and extends outward by crossing the heat-sealed edge; and a first tab resin that is adhered to the positive tab and has (i) a first crossing area in which the positive tab crosses the heat-sealed edge and (ii) a first extension area that extends more outward from the casing than the first crossing area, and, a second tab resin that is adhered to the negative tab and has (i) a second crossing area in which the negative tab crosses the heat-sealed edge and (ii) a second extension area that extends more outward from the casing than the second crossing area, wherein each of the first and second tab resins in the respective crossing areas includes a high melting point resin layer whose melting point is relatively higher than a melting point of each element constituting the first and second extension areas. In other words, the crossing area includes a high melting point resin layer, whereas the extension area includes a resin layer whose melting point is lower than the high melting point resin layer (hereinafter referred to as “low melting point resin layer”) and does not include the high melting point resin layer.

As described above, the construction of a tab resin is different for each area in the laminate-cased battery according to the present invention. In other words, in the laminate-cased battery according to the present invention, a tab resin in the crossing area includes a high melting point resin layer. Therefore, the high melting point resin layer remains without fail even when heated during the heat sealing of the opening edge of the casing. This makes it possible to prevent a metal layer (aluminum (Al) layer or such) in a metal laminate sheet from being directly in contact with the positive and negative tabs.

Also, in the laminate-cased battery according to the present invention, a tab resin in the extension area does not include a high melting point resin layer, but includes a low melting point resin layer. It is easier to bend low melting point resin layers than high melting point resin layers, which results in the positive and negative tabs in the extension area having high bending performance. Therefore, it is possible to reduce the curvature radius of the positive and negative tabs when the positive and negative tabs are bent after a circuit board is mounted, thereby improving space efficiency.

The extension area is hardly heated during the heat sealing of the opening edge of the casing. Therefore, the tab resin in the extension area remains without fail, thereby maintaining insulation between (i) the metal layer exposed at the opening edge of the casing and (i) the positive and negative tabs.

The above-described effect of the laminate-cased battery according to the present invention is achieved by focusing attention on the point that each resin layer used for the tab resin generally has different bending rigidity depending on the melting point, specifically on the point that the bending rigidity of the low melting point resin layers is smaller than that of the high melting point resin layers.

Note that it is possible to adopt the construction that does not include any tab resin in the portions extended from the casing, when only considering the improvement of the bending performance of the positive and negative tabs. However, in a case where the portions do not have any tab resin in practice, the metal layer of the metal laminate sheet, which is exposed at the edge of the casing, makes contact with the positive and negative tabs. Therefore, it is not preferable to remove the tab resin from the extension area.

Furthermore, it is not preferable to adopt the construction in which the tab resin in the crossing area includes only a low melting point resin layer, since this construction increases the risk of the metal layer of the metal laminate sheet making contact with the positive and negative tabs during the heat sealing.

As described above, the laminate-cased battery according to the present invention has a high quality and high energy efficiency, the tabs of which have been bent with a small curvature radius, while securely maintaining insulation between the metal layer of a laminate casing and the tabs when heat-sealing the opening edge of the laminate-cased battery.

The laminate-cased battery according to the present invention can adopt the following variations.

Each of the first and second tab resins in the respective crossing areas has a lamination structure in which the high melting point resin layer is sandwiched on both sides in a thickness direction, by low melting point resin layers whose melting points are lower than the melting point of the high melting point resin layer. Note that, in the crossing area, the low melting point resin layers sandwiching the high melting point resin layer are not necessarily made of the same resin material as the low melting point resin layers of the tab resin in the extension area.

Also, in the laminate-cased battery according to the present invention, a whole thickness of each of the tab resins in the respective extension areas may be thinner than a whole thickness of the tab resin in the crossing area. In this way, the bending rigidity of the tab resin in the extension area is improved by the difference in thickness as well as the different kinds of resin. In other words, the positive and negative tabs have been bent with a smaller curvature, thereby further improving energy efficiency.

Furthermore, in the laminate-cased battery according to the present invention, each of the first and second tab resins in the respective crossing areas may include a polyester layer that is made of polyester as the high melting point resin layer, and each of the first and second tab resins in the respective extension areas may include a layer made of one of modified polypropylene and modified polyethylene as the low melting point resin layer, and may not include the polyester layer.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1A is a perspective view (partial cutaway view) showing a laminate-cased battery according to the conventional technique;

FIG. 1B is a side view showing a tab 86 of the laminate-cased battery according to the conventional technique;

FIG. 2 is a perspective view (partial cutaway view) showing a laminate-cased battery 1 according to the present embodiment;

FIG. 3 is a sectional view showing the construction of an outer edge 20c from which a tab 32 is extended and an inner tab resin 42, in the laminate-cased battery 1 according to the present embodiment;

FIG. 4A is a schematic process chart showing a part of a manufacturing process of the laminate-cased battery 1;

FIG. 4B is a schematic process chart showing a part of the manufacturing process of the laminate-cased battery 1;

FIG. 4C is a schematic process chart showing a part of the manufacturing process of the laminate-cased battery 1;

FIG. 5A is a process chart showing a mounting process of a circuit board 60 on the laminate-cased battery 1;

FIG. 5B is a process chart showing a process of bending the tab 32, after the circuit board 60 is mounted on the laminate-cased battery 1;

FIG. 6A is a sectional view showing the construction of an outer edge and tab resin of a laminate-cased battery, according to a comparison 1; and

FIG. 6B is a sectional view showing the construction of an outer edge and tab resin of a laminate-cased battery, according to a comparison 2.

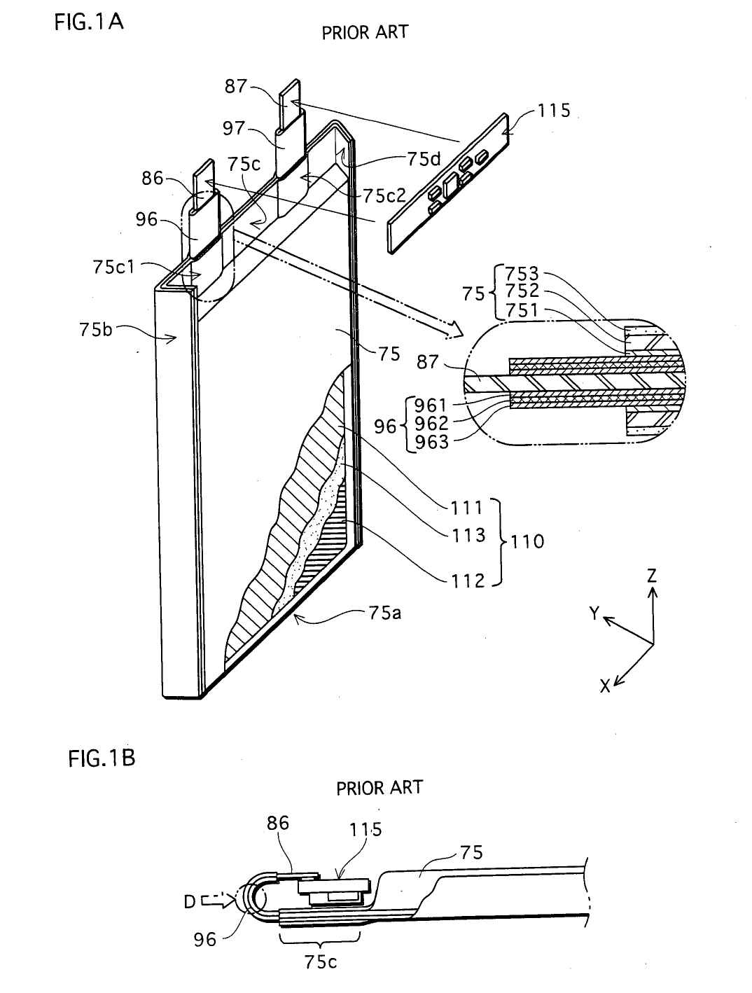

### DESCRIPTION OF THE PREFERRED EMBODIMENT

The following describes the preferred embodiment of the present invention with one example. It should be noted that the embodiment used for the descriptions below is merely one example for the clear and detailed descriptions of the construction of the present invention and the acts/effects achieved from the construction. Therefore the present invention shall not be limited to the embodiment described below, except the essential characteristic parts.

1. Overall Construction

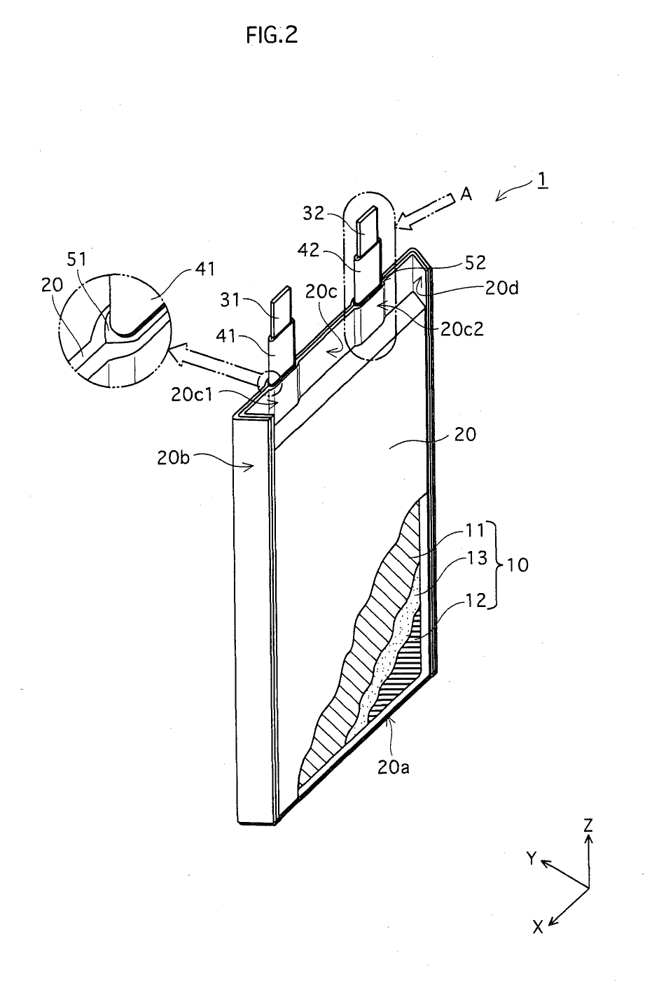

The following describes the construction of a laminate-cased battery 1 according to the present embodiment, with reference to FIG. 2.

As shown in FIG. 2, the laminate-cased battery 1 includes an electrode assembly 10 that is composed of a positive plate 11, a negative plate 12, and a separator 13. The electrode assembly 10 is housed in a housing space of a laminate casing 20. The positive plate 11 is made of aluminum foil to which lithium cobaltate (LiCoO₂) is applied. The negative plate 12 is made of copper foil to which graphite powder is applied. The separator 13 is made of, for example, porous polyethylene having a thickness of 0.02 [mm].

Although not shown in FIG. 2, the electrode assembly 10 is impregnated with polymer electrolyte. The impregnated polymer electrolyte may be a substance made in the following manner. First, Polyethylene Glycol Diacrylate is mixed with EC/DEC mixture (Mass Ratio 30:70) at 1:10 ratio. Then, 1 [mol/L] of LiPF₆ is added to the mixture, and gelatinized through thermal polymerization.

The laminate casing 20 is formed with one metal laminate sheet that has been pressed and bent into a bag-shape. Three outer edges 20b, 20c, and 20d are heat-sealed while a bottom portion 20a positioned at a lower end of the laminate casing 20 in the z axial direction is left unsealed. Here, the outer edge 20c corresponds to an “opening edge of the bag”, and is referred to as “heat-sealed edge” after being heat-sealed.

In the electrode assembly 10, the positive plate 11 and the negative plate 12 are both connected to tabs 31 and 32. The tabs 31 and 32 are extended outward by crossing the outer edge 20c of the laminate casing 20, which is positioned at an upper end of the laminate casing 20 in the z axial direction. The tabs 31 and 32 are adhered to inner tab resins 41 and 42 and sealed part tab resins 51 and 52, in order to increase the adhesive strength with an inner resin layer of the laminate casing 20, and to insulate the tabs 31 and 32 from a metal layer exposed at an edge of the laminate casing 20.

Note that the outer edge 20c of the laminate casing 20, which is positioned at the upper end of the laminate casing 20 in the z axial direction, includes blister portions 20c1 and 20c2 that release the tabs 31 and 32 in their thickness directions. Also, for higher space efficiency, the outer edges 20b and 20d, which are on both sides of the laminate casing 20 in the x axial direction, are bent along an outer surface of a cup portion that houses the electrode assembly 10.

2. Inner Tab Resins 41, 42 and Sealed Part Tab Resins 51, 52

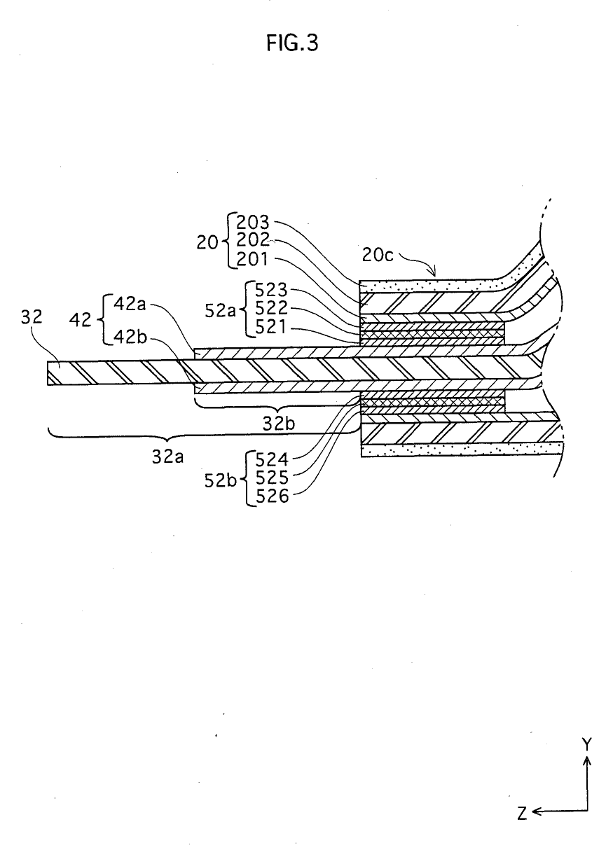

The following describes adhesion states of the inner tab resins 41, 42 and the sealed part tab resins 51, 52, with respect to the tabs 31 and 32, with reference to FIG. 3. FIG. 3 is a sectional view showing in detail a portion viewed in the direction of the arrow A in FIG. 2.

As shown in FIG. 3, the laminate casing 20 of the laminate-cased battery 1 according to the present embodiment has a three-layer structure. Specifically, the laminate casing 20 includes a PP layer 201, an Al layer 202, and an Ny layer 203 laminated in the stated order from the inside. The thicknesses of the layers 201, 202, and 203 are as follows.
PP layer 201: 45[μm]
Al layer 202: 40 [μm]
Ny layer 203: 25[μm]

Although not shown in FIG. 3, a dry laminate adhesive layer having, for example, a thickness of 5 [μm], is arranged between each of the layers 201, 202, and 203.

The inner tab resin 42 is composed of two sheet-shaped components 42a and 42b arranged so as to sandwich the tab 32. The sheet-shaped components 42a and 42b constituting the inner tab resin 42 are adhered to the tab 32, from a portion 32b toward the housing space of the laminate casing 20 without interruption. The portion 32b is part of a region 32a that extends from the outer edge 20c of the laminate casing 20.

The sealed part tab resin 52 is also composed of two sheet-shaped components 52a and 52b. In the outer edge 20c of the laminate casing 20, the sheet-shaped component 52a is arranged between the laminate casing 20 and the sheet-shaped component 42a of the inner tab resin 42, and the sheet-shaped component 52b is arranged between the laminate casing 20 and the sheet-shaped component 42b. The sheet-shaped component 52a of the sealed part tab resin 52 has a three-layer structure including a modified PP layer 521, a PEN layer 522, and a modified PP layer 523. The sheet-shaped component 52b also has a three-layer structure including a modified PP layer 524, a PEN layer 525, and a modified PP layer 526.

Here, the sheet-shaped components 42a and 42b of the inner tab resin 42 are made from modified PP. Therefore, each of the sheet-shaped components 42a and 42b has a lower melting point and smaller bending rigidity than the PEN layers 522 and 525 that are included in the sheet-shaped components 52a and 52b of the sealed part tab resin 52. Also, only the sheet-shaped components 42a and 42b of the inner tab resin 42 are adhered to the region 32a of the tab 32. Therefore, the thickness of the adhesion resin of the tab 32 is smaller than that of the outer edge 20c, since the adhesion resin of the outer edge 20c includes the sheet-shaped components 52a and 52b in addition to the sheet-shaped components 42a and 42b.

Here, FIG. 3 only shows parts related to the tab 32. However, the tab 31, and the inner tab resin 41 and the sealed part tab resin 51 that are adhered thereto also have the same structure as the parts shown in FIG. 3.

3. Manufacturing Method of Laminate-Cased Battery 1

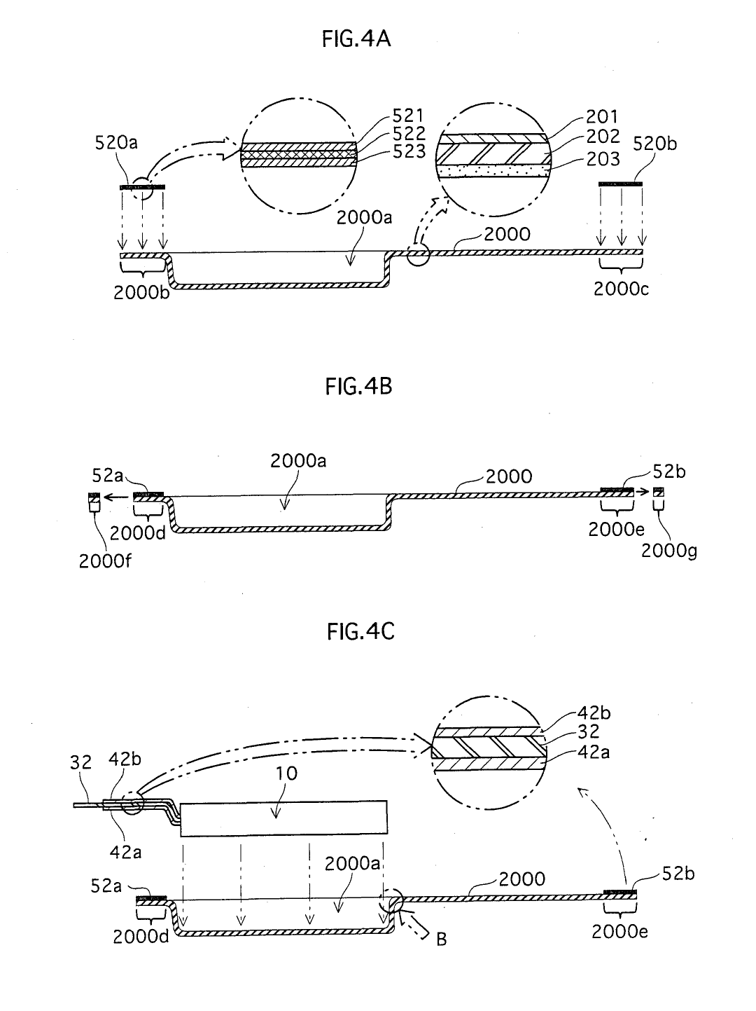

The following describes a manufacturing method of the laminate-cased battery 1, with reference to FIGS. 4A to 4C. Note that FIGS. 4A to 4C only show processes related to the formation of the laminate casing 20.

As shown in FIG. 4A, a recessed portion 2000a, whose size is equivalent to the electrode assembly 10, is formed in a part of a metal laminate sheet 2000 that has a three layer structure including a PP layer 201, an Al layer 202, and an Ny layer 203 (see the enlarged part on the right side of FIG. 4A). The recessed portion 2000a is formed by press work. Then, resin sheets 520a and 520b are adhered to portions 2000b and 2000c that correspond to the outer edge 20c of the metal laminate sheet 2000.

As shown in the enlarged part on the left side of FIG. 4A, the resin sheet 520a has the three-layer structure including the modified PP layer 521, the PEN layer 522, and the modified PP layer 523. The resin sheet 520b also has the same three-layer structure.

As shown in FIG. 4B, outer portions 2000f and 2000g, which are portions of the outer edges of the metal laminate sheet 2000, are removed. At this time, portions of the resin sheets 520a and 520b on the outer portions 2000f and 2000g are also removed. In this way, the outer portions 2000f and 2000g are removed to form (i) remaining portions 2000d, 2000e, and (ii) the sheet-shaped components 52a, 52b whose edges are adjusted.

As shown in FIG. 4C, the electrode assembly 10 to which the positive tab 31 (not shown in FIG. 4C) and the negative tab 32 are adhered is inserted in the recessed portion 2000a formed in the metal laminate sheet 2000. Here, the inner tab resins 41 and 42 (the tab 31 and the inner tab resin 41 are not shown in FIG. 4C) are preliminarily adhered to the positive tab 31 and the negative tab 32. As shown in the enlarged part of FIG. 4C, the inner tab resin 42 is composed of two sheet-shaped components 42a and 42b that are adhered to each other with the tab 32 in between.

As described above, the inner tab resins 41 and 42 have a single-layer structure with modified PP.

Then, with B portion in FIG. 4C as a fulcrum, part of the metal laminate sheet 2000 is bent, in a manner that the sheet-shaped components 52a and 52b sandwich (i) the tab 32 and (ii) the inner tab resin 42 (sheet-shaped components 42a and 42b). Then, appropriate portions of the metal laminate sheet 2000 are heat-sealed. The same applies to the extending portion of the positive tab 31. The other outer edges 20b and 20d are also heat-sealed while the metal laminate sheet 2000 is bent.

In the above-described way, the laminate-cased battery 1 is completed.

4. Advantages

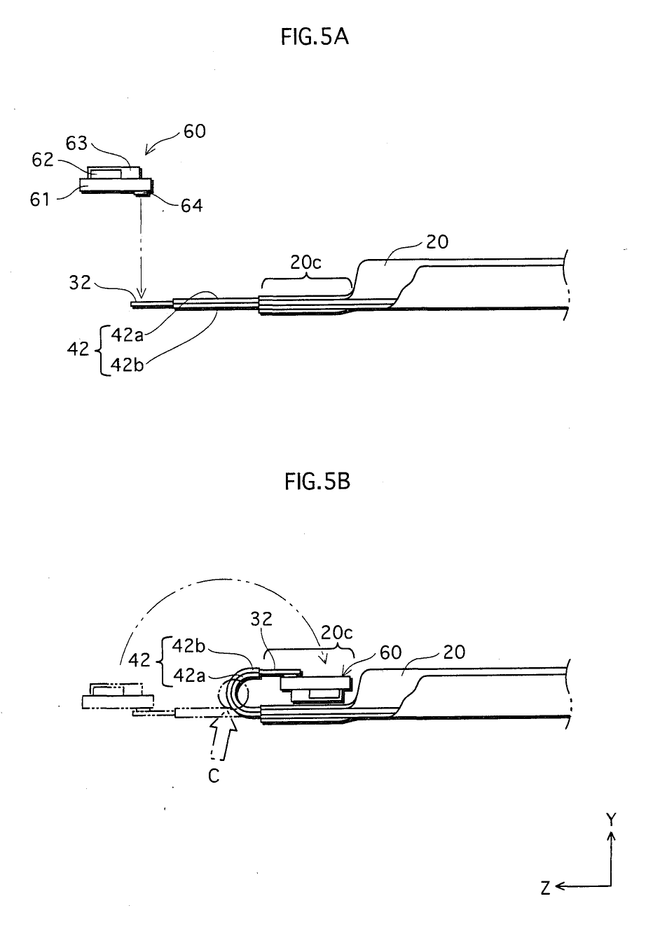

The following describes advantages of the laminate-cased battery 1 according to the present embodiment, with reference to FIG. 3, FIGS. 5A and 5B.

FIG. 3 shows the outer edge 20c of the laminate casing 20 in the laminate-cased battery 1. As shown in FIG. 3, the sheet-shaped components 52a and 52b are respectively inserted between the tab 32 and the laminate casing 20. Here, the sheet-shaped components 52a and 52b constitute the sealed part tab resin 52, which includes the PEN layers 522 and 525. Each of the PEN layers 522 and 525 has a higher heat resistance than modified PP, and remains without fail even after the heat sealing process of the outer edge 20c. As a result, the laminate-cased battery 1 securely maintains insulation between the Al layer 202 of the laminate casing 20 and the tab 32.

Also, in the laminate-cased battery 1, the inner tab resin 42 having a single-layer structure with modified PP is adhered to the tab 32, in the portion 32b that is part of the region 32a extending outward from the laminate casing 20. Here, the inner tab resin 42 is composed of the sheet-shaped components 42a and 42b. The inner tab resin 42 has the single-layer structure with modified PP that has a smaller bending rigidity than the PEN layers 522 and 525 that are included in the sheet-shaped components 52a and 52b of the sealed part tab resin 52. This means that the inner tab resin 42 has a high bending performance after the circuit board is mounted, which is advantageous when manufacturing batteries having high energy efficiency.

Specifically, as shown in FIG. 5A, the circuit board 60 is mounted on each of the positive and negative tabs 31 and the negative tab 32 (the positive tab 31 is not shown in FIG. 5A or FIG. 5B), of the laminate-cased battery 1. The circuit board 60 includes a substrate 61, electronic components 62 and 63, and a land 64. The electronic components 62 and 63 are mounted on one main surface of the substrate 61. The land 64 corresponds to each of the positive tab 31 and the negative tab 32, and is formed on the other main surface of the substrate 61. The circuit board 60 is attached to the laminate-cased battery 1 by soldering the land 64 to each of the tabs 31 and 32.

As shown in FIG. 5B, the circuit board 60 attached to each of the tabs 31 and 32 is arranged in a space located at the upper end of the laminate casing 20 in the y axial direction of the outer edge 20c. In other words, the tabs 31 and 32 are bent in positions where the inner tab resins 41 and 42 are adhered to, so that the circuit boards 60 are arranged at the upper end of the laminate casing 20 in the y axial direction of the outer edge 20c.

In the laminate-cased battery 1 according to the present invention, only the inner tab resins 41 and 42 that have a single-layer structure with modified PP are adhered to the portions extending from the laminate-cased battery 20. This makes it possible to perform a bending work while the curvature of a portion C is small.

Therefore, in the laminate-cased battery 1 according to the present invention, it is possible to achieve high space efficiency with respect to the bending of the tabs 31 and 32, while maintaining insulation between (i) the Al layer 202 of the laminate casing 20 and (ii) the tabs 31 and 32. Consequently, the laminate-cased battery 1 has a high quality and high energy efficiency.

5. Confirmatory Experiment

### Example

The laminate-cased battery 1 according to the above-described embodiment is provided as an example. The following are the values of the tab resins 41, 42, 51, and 52.

Thickness of each of the sheet-shaped components 42a and 42b; 0.06 [mm]

Extension length of each of the inner tab resins 41 and 42 from the laminate casing 20; 2.0 [mm]

Thickness of each of the PEN layers 522 and 525 in the sheet-shaped components 52a and 52b; 0.015 [mm]

(Comparison 1)

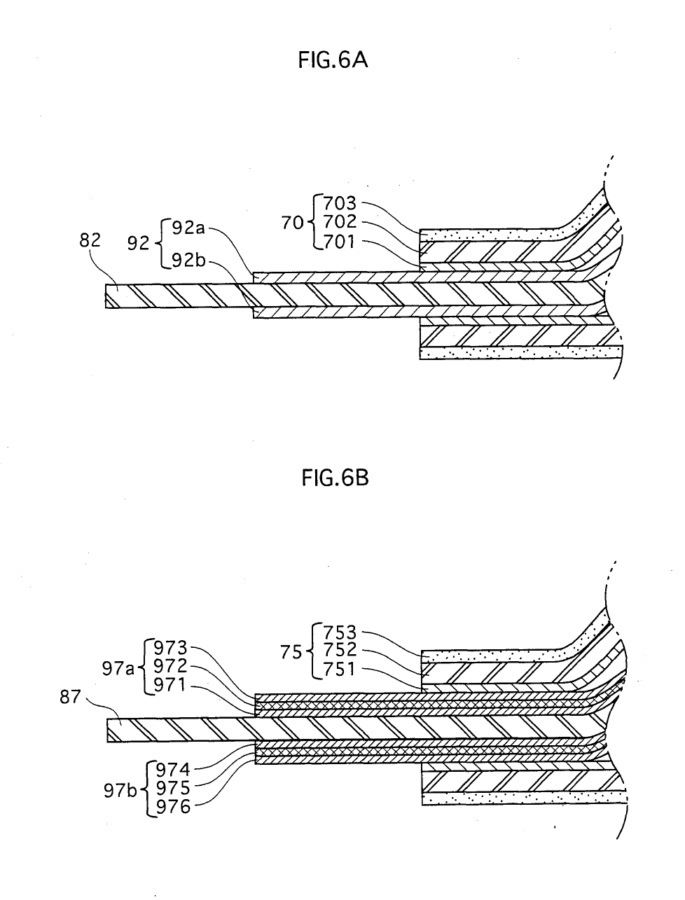

As shown in FIG. 6A, a laminate-cased battery according to a comparison 1 is different from the laminate-cased battery 1 according to the above-described embodiment, on the point that the sealed part tab resins 51 and 52 are not inserted. That is, in the laminate-cased battery according to the comparison 1, a tab resin 92 (sheet-shaped components 92a and 92b) having a single-layer structure with modified PP is adhered to a tab 82, and a PP layer 701 of a laminate casing 70 and a tab resin 92 are inserted between an Al layer 702 of the laminate casing 70 and the tab 82. Note that the laminate-cased battery according to the comparison 1 has the same construction as the laminate-cased battery 1 according to the above-described embodiment, except the construction of the tab resin 92.

Thickness of each of the sheet-shaped components 92a and 92b; 0.06 [mm]

Extension length of the tab resin 92 from the laminate casing 70; 2.0 [mm]

(Comparison 2)

As shown in FIG. 6B, in a laminate-cased battery according to a comparison 2, a tab resin composed of sheet-shaped components 97a and 97b that each have a three-layer structure is adhered to a tab 87, instead of the tab resin 92 of the laminate-cased battery according to the comparison 1. The sheet-shaped component 97a has a three-layer structure including a modified PP layer 971, a PEN layer 972, and a modified PP layer 973, and the sheet-shaped component 97b has a three-layer structure including a modified PP layer 974, a PEN layer 975, and a modified PP layer 976. A laminate casing 75 has a three-layer structure including a PP layer 751, an Al layer 752, and a Ny layer 753, which is the same structure as the laminate casings in the above-described embodiment and the comparison 1.

Thickness of each of the modified PP layers 971 and 974; 0.03 [mm]

Thickness of each of the PEN layers 972 and 975; 0.015 [mm]

Thickness of each of the modified PP layers 973 and 976; 0.03 [mm]

Extension length of each of the tab sheet-shaped components 97a and 97b from the laminate casing 75; 2.0 [mm]

### (Short Circuits During Heat Sealing Observed)

When manufacturing laminate-cased batteries according to the above-described embodiment, comparisons 1 and 2, short circuits caused by heat sealing were observed (Contact between an Al layer of a laminate casing and a tab). The following shows a sealing condition after observing 50 samples for each of the laminate-cased batteries.

Sealing pressure; 1000 [N]

Heating temperature; 190[° C.]

Number of pieces experimented; 50 [pieces] each

TABLE 1

| | Occurrence of Short Circuit[pieces] |
|---|---|
| Example | 0/50 |
| Comparison 1 | 23/50 |
| Comparison 2 | 0/50 |

As shown in a table 1, in the laminate-cased battery of the comparison 1, 23 out of 50 tested samples shorted out. In other words, in the laminate-cased battery of the comparison 1, only the tab resin 92 having the single-layer structure with the modified PP is adhered to the tab 82. Therefore, during a heat sealing process in which the outer edge of the laminate casing 70 is sealed, the Al layer 702 of the laminate casing 70 is likely to be electrically in contact with the tab 82.

Short circuits were not observed in the laminate-cased batteries according to the above-described embodiment and the comparison 2.

### (Easiness in Bending Tabs)

In the laminate-cased batteries according to the above-described embodiment and the comparison 2, portions to which the tab resins 42 and 97 are adhered were bent in the following condition. Then, the spring back angles of the portions were measured. The condition of the experiment is as follows.

Condition; 2 [kgf] (19.6 [N]) Additional weight; 2 [sec.] Hold

Measurement; Measure angle after leaving for 6 [hr.]

Number of experiments; 50 [pieces] each

TABLE 2

| | Average Springback Angle [°] |
|---|---|
| Example | 34 |
| Comparison 1 | — |
| Comparison 2 | 60 |

As shown in FIG. 2, in the laminate-cased battery according to the comparison 2, an average springback angle after leaving for 6 [hr.] is 60[°]. In the laminate-cased battery according to the above-described embodiment, however, an average springback angle after leaving for 6 [hr.] is 34[°]. This means that the springback of the laminate-cased battery according to the above-described embodiment is 26[°] smaller than that of the laminate-cased battery according to the comparison 2.

Therefore, the laminate-cased battery according to the above-described embodiment has an excellent bending performance in the tabs 31 and 32, compared to the laminate-cased battery according to the comparison 2. As a result, the tabs 31 and 32 have been bent with small curvature, which is advantageous in terms of the energy efficiency.

6. Others

In the above-described embodiment, the inner tab resins 41 and 42 have a single-layer structure with modified PP. However, it is possible to adopt other materials and a multilayer structure. In this case, it is necessary to select a material having a lower melting point and a smaller bending rigidity than the PEN layers 522 and 525 included in the sealed part tab resins 51 and 52. It is also preferable that the thickness of the inner tab resins 41 and 42 is thin, when considering the bending rigidity. The material of the inner tab resins 41 and 42 does not need to be modified PP, and may be, for example, modified PE.

Also, although the laminate casing 20 of the three-side sealing type is adopted in the above-described embodiment, it is also possible to adopt a laminate casing of a four-side sealing type. In the four-side sealing type, after two metal laminate sheets are put together, four sides of the outer edges are all sealed. Also, in the above-described embodiment, the positive tab 31 and the negative tab 32 are extended from the same outer edge 20c. However, it is possible to adopt a structure where the tabs 31 and 32 are extended from different edge portions.

Although the electrode assembly 10 having a winding structure is adopted in the above-described embodiment, it is possible to adopt an electrode assembly having a lamination (stack) structure.

Note that the values adopted in the above-described embodiment are merely exemplary, and may be changed when necessary.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A laminate-cased battery comprising:
an electrode assembly including a positive plate and a negative plate;
a casing that is made of a metal laminate sheet composed of a metal layer and resin layers laminated on both main surfaces of the metal layer, the metal laminate sheet being formed into a bag, so as to enclose a space substantially in a shape of a rectangular parallelepiped, an opening edge of the bag being heat-sealed with the electrode assembly housed in the bag;
a positive tab that is made of a conductive material, is connected to the positive plate, and extends outward by crossing the heat-sealed edge;
a negative tab that is made of a conductive material, is connected to the negative plate, and extends outward by crossing the heat-sealed edge; and
a first tab resin that is adhered to the positive tab and has (i) a first crossing area in which the positive tab crosses the heat-sealed edge and (ii) a first extension area that extends more outward from the casing than the first crossing area, and, a second tab resin that is adhered to the negative tab and has (i) a second crossing area in which the negative tab crosses the heat-sealed edge and (ii) a second extension area that extends more outward from the casing than the second crossing area, wherein
each of the first and second tab resins in the respective crossing areas includes a high melting point resin layer whose melting point is relatively higher than a melting point of each element constituting the first and second extension areas.

2. The laminate-cased battery of claim 1, wherein
each of the first and second tab resins in the respective crossing areas has a lamination structure in which the high melting point resin layer is sandwiched on both sides in a thickness direction, by low melting point resin layers whose melting points are lower than the melting point of the high melting point resin layer.

3. The laminate-cased battery of claim 1, wherein
a whole thickness of each of the tab resins in the respective extension areas is thinner than a whole thickness of the tab resin in the crossing area.

4. The laminate-cased battery of claim 1, wherein
each of the first and second tab resins in the respective crossing areas includes a polyester layer that is made of polyester, and
each of the first and second tab resins in the respective extension, areas includes a layer made of one of modified polypropylene and modified polyethylene, and does not include the polyester layer.
